(19) United States
(12) Patent Application Publication
(10) Pub. No.: US 2014/0189526 A1
(43) Pub. Date: Jul. 3, 2014

(54) CHANGING LOG FILE CONTENT GENERATION

(71) Applicant: INTERNATIONAL BUSINESS MACHINES CORPORATION, Armonk, NY (US)

(72) Inventors: Danny Y. Chen, Austin, TX (US); Ravi K. Kosaraju, Johnston, RI (US); Fabian F. Morgan, Austin, TX (US)

(73) Assignee: International Business Machines Corporation, Armonk, NY (US)

(21) Appl. No.: 13/732,566

(22) Filed: Jan. 2, 2013

(51) Int. Cl. G06F 3/0484

(52) U.S. Cl. CPC G06F 3/0484
USPC 715/745

(57) ABSTRACT

In a method for changing log file content generation, a computer extracts content of a log file. The content was generated by one or more computer programs at run-time. The content comprises a plurality of portions. The computer causes the extracted content to be displayed in a user interface. The computer detects a user interaction in the user interface. The user interaction manipulates at least one of the portions. The computer generates a rule for generating future log file content, wherein the generated rule is based on the user interaction in the user interface.

### TECHNICAL FIELD

The present invention relates generally to managing the content of log files, and more specifically to a method, system, and computer program product for changing log file generation for log files.

### BACKGROUND

Computer data logging is the process of recording events, with an automated computer program, to provide an audit trail that can be used to understand activity of a system and to diagnose problems. Logs are often used by software developers to aid in the debugging of the operation of an application. A stream of messages in time-sequence often comprises a log. Logs may be directed to files and stored on disk.

Logs are essential to understand the activities of complex systems, particularly in the case of applications with little user interaction (such as server applications). Log messages must usually be interpreted with respect to the internal state of their source (e.g., application) and announce security-relevant or operations-relevant events (e.g., a user login, or a systems error).

Most databases maintain some kind of transaction log. These logs record changes to stored database data to allow the database to recover from crashes or other errors and maintain the stored data in a consistent state. Most database systems have both a log in the general sense described above, and a transaction log.

In large and complex multi-user applications that are database driven, it is common to direct Structured Query Language (SQL) statements that are generated at run-time from fixed static clauses to a log file. These clauses may have placeholders to substitute actual data that was requested or required for update at run-time. Furthermore, these clauses may be created in various portions of the applications by end-users/administrators, may be configured out-of-the-box in various applications but modifiable by end users/administrators, or may be ensconced in application code so that they are not modifiable by users. The method of clause configuration may depend on a combination of the application design and/or supported application functionality, amongst other considerations.

### SUMMARY

According to one embodiment of the present invention, a method for changing log file content generation is provided. The method includes a computer extracting the content of a log file. The content was generated by one or more computer programs at run-time. The content comprises a plurality of portions. The method further includes the computer causing the extracted content to be displayed in a user interface. The method further includes the computer detecting a user interaction in the user interface. The user interaction includes manipulating at least one of the portions. The method further includes the computer generating a rule for generating future log file content, wherein the generated rule is based on the user interaction in the user interface.

According to another embodiment of the present invention, a computer program product for changing log file content generation is provided. The computer program product includes one or more computer-readable tangible storage devices and program instructions stored on at least one of the one or more storage devices. The program instructions include program instructions to extract the content of a log file. The content was generated by one or more computer programs at run-time. The content comprises a plurality of portions. The program instructions include program instructions to cause the extracted content to be displayed in a user interface. The program instructions include program instructions to detect a user interaction in the user interface. The user interaction includes manipulating at least one of the portions. The program instructions include program instructions to generate a rule for generating future log file content, wherein the generated rule is based on the user interaction in the user interface.

According to another embodiment of the present invention, a computer system for changing log file content generation is provided. The computer system includes one or more processors, one or more computer-readable memories, one or more computer-readable tangible storage devices and program instructions which are stored on at least one of the one or more storage devices for execution by at least one of the one or more processors via at least one of the one or more memories. The program instructions include program instructions to extract the content of a log file. The content was generated by one or more computer programs at run-time. The content comprises a plurality of portions. The program instructions include program instructions to cause the extracted content to be displayed in a user interface. The program instructions include program instructions to detect a user interaction in the user interface. The user interaction includes manipulating at least one of the portions. The program instructions include program instructions to generate a rule for generating future log file content, wherein the generated rule is based on the user interaction in the user interface.

### BRIEF DESCRIPTION OF THE SEVERAL VIEWS OF THE DRAWINGS

FIG. 1 depicts a diagram of a computing system in accordance with one embodiment of the present invention.

FIGS. 2A and 2B depict exemplary user interfaces to an interactive log viewer program in accordance with one embodiment of the present invention.

FIG. 3 depicts an exemplary rule for generating future content in accordance with one embodiment of the present invention.

FIG. 4 depicts a flowchart of the steps of an interactive log viewer program executing within the computing system of FIG. 1, for generating a rule for generating future content, in accordance with one embodiment of the present invention.

FIG. 5 is a block diagram of internal and external components of the client computer and the server of FIG. 1 in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

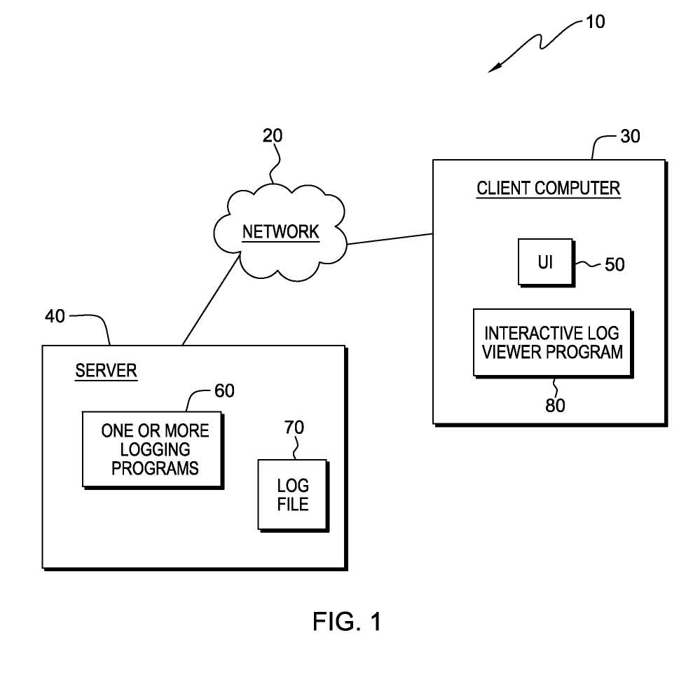

FIG. 1 depicts a diagram of a computing system 10 in accordance with one embodiment of the present invention. FIG. 1 provides only an illustration of one embodiment and does not imply any limitations with regard to the environments in which different embodiments may be implemented.

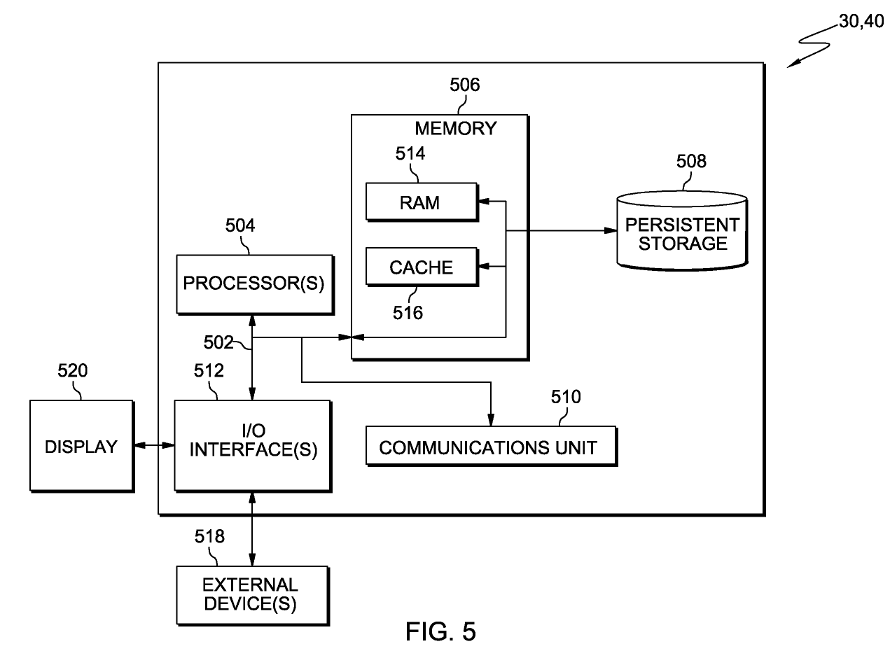

In the depicted embodiment, computing system 10 includes a client computer 30 and a server 40 interconnected over a network 20. Client computer 30 and server 40 may each include components as depicted in further detail with respect to FIG. 5. Client computer 30 may be a desktop computer, laptop computer, tablet computer, personal digital assistant (PDA), thin client, or smart phone. In general, client computer 30 may be any electronic device or computing system capable of sending and receiving data, and communicating with server 40 over network 20. Server 40 may be a management server, a web server, or any other electronic device or computing system capable of receiving and sending data. In other embodiments, server 40 may represent a server computing system utilizing multiple computers as a server system, such as in a cloud computing environment. Computing system 10 may include additional servers, client computers, or other devices not shown. Network 20 may be a local area network (LAN), a wide area network (WAN) such as the Internet, any combination thereof, or any combination of connections and protocols that will support communications between client computer 30 and server 40 in accordance with embodiments of the invention. Network 20 may include wired, wireless, or fiber optic connections.

A user interface (UI) 50 operates on client computer 30 to visualize content, such as menus and icons, and to allow a user to interact with an application accessible to client computer 30. In one embodiment, UI 50 comprises an interface to an interactive log viewer program 80. UI 50 may display data received from interactive log viewer program 80 and send input to interactive log viewer program 80. In other embodiments, UI 50 may comprise one or more interfaces such as, an operating system interface and/or application interfaces.

Server 40 contains one or more logging programs 60 and a log file 70. One or more logging programs 60 operates to generate and write content to log file 70. In one embodiment, one or more logging programs 60 is one computer program that generates content from different functions or methods within the program and writes the content to log file 70. In another embodiment, one or more logging programs 60 is multiple independent computer programs that generate and write content to log file 70. In one embodiment, the content may include log messages.

In one embodiment, a log message may be a SQL statement generated by one or more logging programs 60 from fixed static SQL clauses. A fixed static SQL clause may have placeholders to substitute actual data that was requested or required at run-time. In one embodiment, the log message may be any text string with contextual information. The syntax and semantics of data within log messages may be application or vendor-specific.

In one embodiment, the log message may include a plurality of portions. For example, where the log message is an SQL statement, the SQL statement may contain a plurality of SQL clauses generated from fixed static SQL clauses.

In one embodiment, one or more logging programs 60 resides on server 40. In one embodiment, one or more logging programs 60 may reside on another server or another computing device, provided that one or more logging programs 60 has access to log file 70.

Log file 70 may be a data file that contains content generated by one or more logging programs 60. In one embodiment, log file 70 may be located on server 40. In another embodiment, log file 70 may be located on another server or another computing device, provided that log file 70 is accessible to one or more logging programs 60 and interactive log viewer program 80.

Interactive log viewer program 80 operates to generate a rule for generating future content. Interactive log viewer program 80 may generate the rule based on a user interaction in UI 50. In one embodiment, interactive log viewer program 80 resides on client computer 30. In another embodiment, interactive log viewer program 80 may reside on another server or another computing device, provided that interactive log viewer program 80 has access to log file 70 and provided that interactive log viewer program 80 can communicate with UI 50.

In one embodiment, interactive log viewer program 80 extracts content from log file 70, the content including a plurality of portions. Interactive log viewer program 80 causes the plurality of portions to be displayed in UI 50 and detects a user interaction in UI 50.

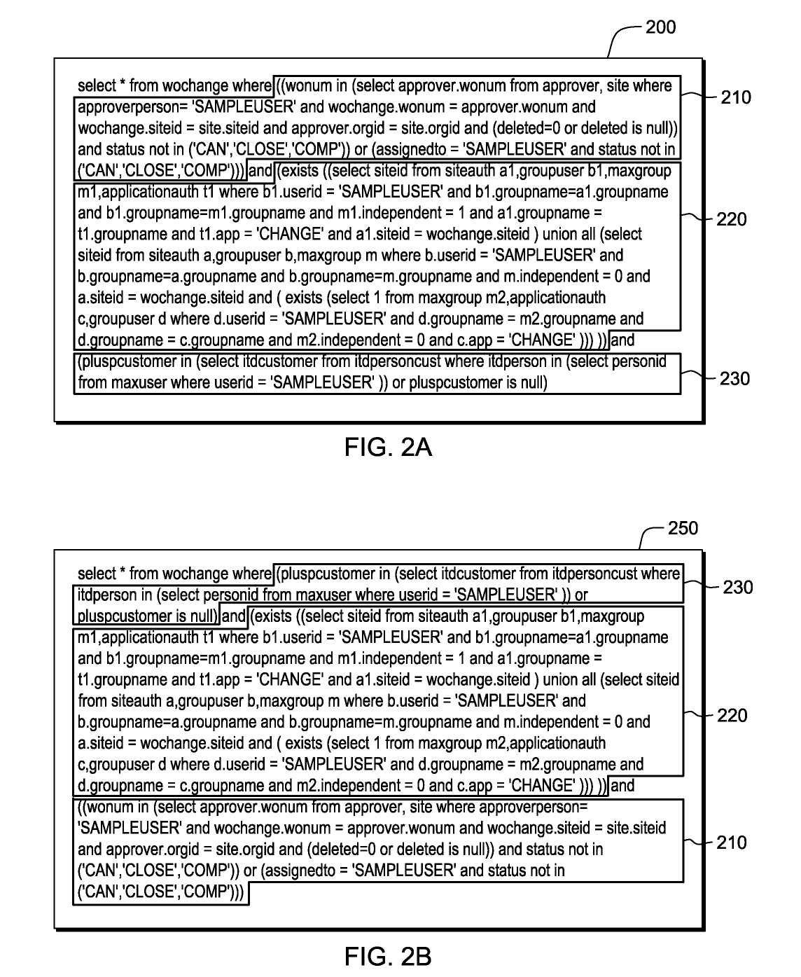

FIGS. 2A and 2B depict exemplary user interfaces to interactive log viewer program 80 in accordance with one embodiment of the present invention. A UI 200 of FIG. 2A and a UI 250 of FIG. 2B are each an example of UI 50 of FIG. 1, and each may allow a user to see displayed content from interactive log viewer program 80 and to interact with the displayed content.

FIG. 2A depicts UI 200 before a user interaction with displayed content. UI 200 contains content as originally extracted from log file 70. The content includes portions 210, 220, and 230 in that respective order. Each of portions 210, 220, and 230 is an SQL clause generated from a static fixed SQL clause from a unique function/program within one or more logging programs 60. Each of portions 210, 220, and 230 is enclosed by a line to indicate that it is a portion that originates from a unique function/program within one or more logging programs 60. In another embodiment, each of portions 210, 220, and 230 may be highlighted in a unique color corresponding to the function/program that generated the portion. In another embodiment, each of portions 210, 220, and 230 may be hovered over with a mouse pointer in UI 200 to show which function/program within one or more logging programs 60 that the portion came from. For example, when the mouse pointer hovers over clause 230, UI 200 may generate a popup window indicating that portion 230 came from a “restriction” program within one or more logging programs 60.

In this example, portion 210 was generated from a “query” program within one or more logging programs 60 and portion 230 was generated from a “restriction” program within one or more logging programs 60. Portion 220 was generated by embedded base SQL code of one or more logging programs 60. The output of the SQL generation may differ based on the user ID of the user using one or more logging programs 60. For example, portion 230 could be different for “SAMPLEUSER” versus another user ID based on the security group the users are in. A user may select and move portions 210, 220, and 230 around within UI 200.

FIG. 2B depicts UI 250 after a user interaction with displayed content. User interface window 250 includes portions 230, 220, and 210 in that respective order. The user has performed the user interaction by selecting and moving portion 230 above portion 220 and portion 210 below portion 220. The user may determine that one or more logging programs 60 should generate and write portions 230, 220, and 210 in that particular order only for the user ID, “SAMPLEUSER.” The user may also determine that one or more logging programs 60 should generate and write portions 230, 220, and 210 in that particular order for portions associated with any user ID. In this example, the user determines that one or more logging programs 60 should generate and write portions 230, 220, and 210 in that respective order to log file 70 only for the user ID, “SAMPLEUSER.”

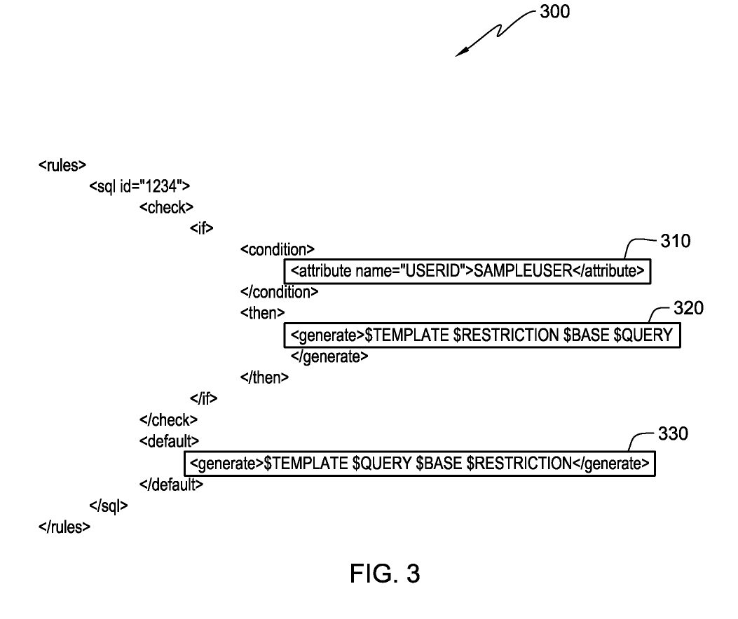

FIG. 3 depicts an exemplary rule for generating future content in accordance with one embodiment of the present invention. Interactive log viewer program 80 generates a rule for generating future content. Interactive log viewer program 80 may generate the rule based on a user interaction in UI 50. In this example, rule 300 is based on the user interaction of selecting and moving portion 230 above portion 220 and portion 210 below portion 220 as described above in reference to FIG. 2B. Rule 300 may be stored on server 40. Rule 300 may be used for the future generation of content to be written to log file 70 by one or more logging programs 60. In this example, rule 300 is in XML format.

Rule 300 applies to a particular SQL statement designated “1234.” SQL statement “1234” includes the fixed static SQL clauses that generate portions 210, 220, and 230. Rule 300 contains condition 310, element 320, and element 330. Element 330 describes the default order of portion generation. The default order of portion generation is “TEMPLATE” (e.g., select * from wochange where), “QUERY” (e.g., portion 210), “BASE” (e.g., portion 220), and “RESTRICTION” (e.g., portion 230). Element 320 describes the order of portion generation if condition 310 is met. The order of portion generation if condition 310 is met is “TEMPLATE” (e.g., select * from wochange where), “RESTRICTION” (e.g., portion 230), “BASE” (e.g., portion 220), and “QUERY” (e.g., portion 210). Condition 310 is a condition that must be met before one or more logging programs 60 will generate the content according to the generated rule. Condition 310 describes an attribute that must be present for the portions to be generated according to element 330. If the SQL statement is generated with the user ID, “SAMPLEUSER,” (e.g., as a result of the actions performed by “SAMPLEUSER” while logged into one or more logging programs 60), one or more logging programs 60 will generate portions 210, 220, and 230 according to element 330.

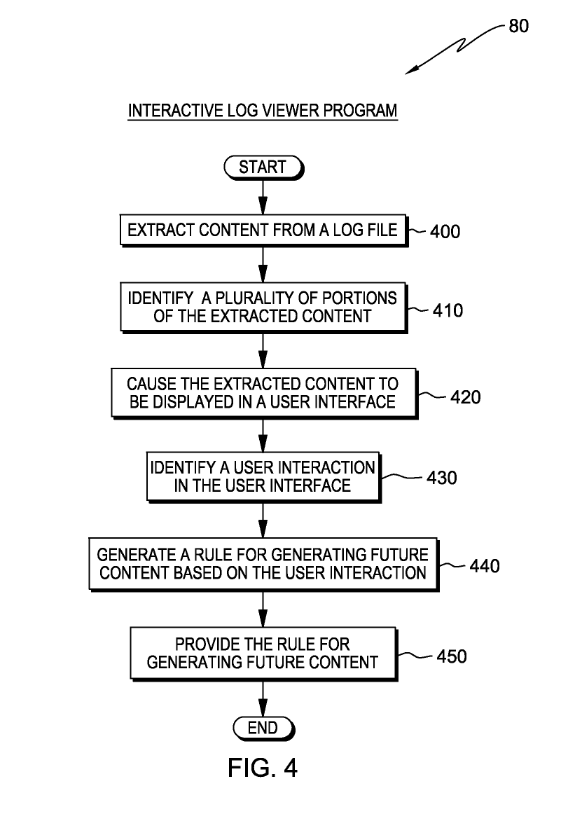

FIG. 4 depicts a flowchart of the steps of interactive log viewer program 80 executing within the computing system of FIG. 1, for generating a rule for generating future content, in accordance with one embodiment of the present invention.

In one embodiment, initially, one or more logging programs 60 generates and writes content to log file 70. In one embodiment, the content may include log messages. Each log message may include a plurality of portions. For example, a log message may include a SQL statement which contains a plurality of portions that are SQL clauses generated from fixed static SQL clauses. One or more logging programs 60 generates the plurality of SQL clauses from fixed static SQL clauses according to a default rule and writes the content to log file 70.

In step 400, interactive log viewer program 80 extracts content from log file 70. In one embodiment, interactive log viewer program 80 accesses log file 70 over network 20 and reads an SQL statement contained within log file 70.

Interactive log viewer program 80 identifies a plurality of portions contained in the content extracted from log file 70 (step 410). In one embodiment, at step 410, interactive log viewer program 80 identifies the plurality of SQL clauses contained in the SQL statement. Interactive log viewer program 80 may accesses user-supplied metadata tables that contain fixed static SQL clauses that are each associated with a specific function or program within one or more logging programs 60 to identify the plurality of SQL clauses in the SQL statement. The metadata tables may contain a variable generic format of the fixed static SQL clauses. The variable generic format of a fixed static SQL clause contains one or more place-holder variables that represent a value that is resolved at runtime. Interactive log viewer program 80 converts each SQL clause in the plurality of SQL clauses contained in the SQL statement to the variable generic format of the fixed static SQL clauses. Interactive log viewer program 80 compares the converted plurality of SQL clauses contained in the SQL statement to the variable generic format of the fixed static SQL clauses contained in the metadata tables to determine the function or program associated with each SQL clause of the plurality of SQL clauses contained in the SQL statement. In general, comparing the converted plurality of SQL clauses contained in the SQL statement to the variable generic format of the fixed static SQL clauses contained in the metadata tables is referred to as pattern matching. Interactive log viewer program 80 can use pattern matching for any other type of content with a plurality of portions.

In another embodiment, to identify the plurality of SQL clauses in the SQL statement, interactive log viewer program 80 may access a user-supplied table that contains specific tags that are each associated with a specific function or program within one or more logging programs 60. In this embodiment, the plurality of portions contained in the content extracted from log file 70 each contain a tag, added by one or more logged content programs 60, to denote the function or program associated with each portion of the plurality of portions. Interactive log viewer program 80 compares the tag contained in each portion of the plurality of portions to tags contained in the table to determine the function or program associated with each portion of the plurality of portions contained in the content.

In step 420, interactive log viewer program 80 causes the content extracted from log file 70 to be displayed in UI 50. In one embodiment, interactive log viewer program 80 sends the plurality of SQL clauses contained in the SQL statement to UI 50 to be displayed in an interactive form.

In one embodiment, interactive log viewer program 80 causes the plurality of SQL clauses contained in the SQL statement to be displayed with an indication of the function or program within one or more logging programs 60 associated with each SQL clause of the plurality of SQL clauses. For example, interactive log viewer program 80 causes each clause to be displayed as highlighted with a specific color that represents the program/function it is associated with. In another example, interactive log viewer program 80 causes each clause to be displayed as enclosed by a line that has a label denoting the program/function it is associated with. Any other method of indicating the program/function associated with each SQL clause of the plurality of SQL clauses may be used by interactive log viewer program 80.

In one embodiment, interactive log viewer program 80 causes each SQL clause of the plurality of SQL clauses contained in the SQL statement to be displayed as objects that can be selected and manipulated individually in UI 50. Each SQL clause can be deleted or manipulated using “drag and drop.”

In step 430, interactive log viewer program 80 identifies a user interaction in UI 50. In one embodiment, the user interaction may be a manipulation of a SQL clause of the displayed plurality of SQL clauses. For example, a user may reorder the plurality of SQL clauses as discussed in reference to FIG. 2B using “drag and drop.” In another example, a user may delete one or more SQL clauses of the plurality of SQL clauses. UI 50 detects an event and sends an indication of the event to interactive log viewer program 80. Interactive log viewer program 80 identifies the user interaction based on the indication of the event detected by UI 50. For example, interactive log viewer program 80 identifies the user interaction as the reordering of the plurality of SQL clauses.

In step 440, interactive log viewer program 80 generates a rule for generating future log file content. The generated rule is based on the user interaction in UI 50 identified in step 430. In one embodiment, the rule may be written in XML format.

In one embodiment, interactive log viewer program 80 creates a rule referencing the generation of the SQL statement extracted from log file 70. The rule will direct the future generation of the plurality of SQL clauses contained in the SQL statement. For example, one or more logging programs 60 generates the plurality of SQL clauses from fixed static SQL clauses according to a default rule. The default rule directs the plurality of SQL clauses to be generated in a certain order. The user interaction in UI 50 identified in step 430 indicates a reordering of the plurality of SQL clauses. Interactive log viewer program 80 writes the rule to direct the plurality of SQL clauses to be generated in the order indicated by the user interaction in UI 50. In another example, one or more logging programs 60 generates the plurality of SQL clauses from fixed static SQL clauses according to a default rule. The default rule directs the plurality of SQL clauses to be generated in a certain order. The user interaction in UI 50 identified in step 430 may indicate a deletion of one or more SQL clauses of the plurality of SQL clauses. Interactive log viewer program 80 writes the rule to direct the plurality of SQL clauses to be generated without the one or more SQL clauses of the plurality of SQL clauses that were deleted as indicated by the user interaction in UI 50.

In another embodiment, a condition may be defined in the rule that must be met before the plurality of SQL clauses are generated according to the order indicated by the user interaction in UI 50. The condition may describe an attribute that must be present for the plurality of SQL clauses to be generated according to the order indicated by the user interaction in UI 50. In one embodiment, interactive log viewer program 80 prompts the user to indicate an attribute. The prompt may be in the form of a pop up sent to UI 50 by interactive log viewer program 80. The pop up may include a text box for the user to enter an attribute. In another embodiment, interactive log viewer program 80 may determine an attribute by searching the plurality of SQL clauses in the SQL statement for a common user ID, record ID, or record status.

For example, the attribute is generally a piece of data that is requested at run-time to fill placeholders in the fixed static SQL clauses to generate the plurality of SQL clauses contained in the SQL statement. An attribute may be a user ID, a record ID, or a record status. A user may condition the generation of the plurality of SQL clauses according to the order indicated by the user interaction in UI 50 on the presence of the attribute filling the placeholder, or the user may set no conditions. If the user sets no conditions, every generation of the plurality of SQL clauses contained in the SQL statement will be generated according to the order indicated by the user interaction in UI 50.

In step 450, interactive log viewer program 80 provides the rule for generating future log file content based on the user interaction in UI 50 to one or more logging programs 60. In one embodiment, interactive log viewer program 80 sends an indication of the existence of the rule and/or the location of the rule to one or more logging programs 60. In another embodiment, interactive log viewer program 80 may be implemented as a plugin associated with one or more logging programs 60. For example, interactive log viewer program 80 modifies the SQL code that directs the generation of the plurality of SQL clauses according to the rule based on the user interaction in UI 50.

FIG. 5 depicts a block diagram of components of client computer 30 and server 40 in accordance with one embodiment of the present invention. It should be appreciated that FIG. 5 provides only an illustration of one implementation and does not imply any limitations with regard to the environments in which different embodiments may be implemented. Many modifications to the depicted environment may be made.

Client computer 30 and server 40 each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In one embodiment, memory 506 includes random access memory (RAM) 514 and cache memory 516. In general, memory 506 can include any suitable volatile or non-volatile computer-readable storage media.

UI 50 and interactive log viewer program 80 are stored in persistent storage 508 of client computer 30 for execution by one or more of the respective computer processors 504 of client computer 30 via one or more memories of memory 506 of client computer 30. One or more logging programs 60 and log file 70 are stored in persistent storage 508 of server 40 for execution and/or access by one or more of the respective computer processors 504 of server 40 via one or more memories of memory 506 of server 40. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other servers, data processing systems, or devices. In these examples, communications unit 510 includes one or more network interface cards. Communications unit 510 may provide communications through the use of either or both physical and wireless communications links. UI 50 and interactive log viewer program 80 may be downloaded to persistent storage 508 of client computer 30 through communications unit 510 of client computer 30. One or more logging programs 60 and log file 70 may be downloaded to persistent storage 508 of server 40 through communications unit 510 of server 40.

I/O interface(s) 512 allows for input and output of data with other devices that may be connected to client computer 30 or server 40. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., UI 50 and interactive log viewer program 80 can be stored on such portable computer-readable storage media and can be loaded onto persistent storage 508 of client computer 30 via I/O interface(s) 512 of client computer 30. Software and data used to practice embodiments of the present invention, e.g., one or more logging programs 60 and log file 70 can be stored on such portable computer-readable storage media and can be loaded onto persistent storage 508 of server 40 via I/O interface(s) 512 of server 40. I/O interface(s) 512 also connect to a display 520.

Display 520 provides a mechanism to display data to a user and may be, for example, a computer monitor or a touch screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for changing log file content generation, the method comprising the steps of:
a computer extracting content of a log file, the content having been generated by one or more computer programs at run-time, the content comprising a plurality of portions;
the computer causing the extracted content to be displayed in a user interface;
the computer receiving an indication of a user interaction in the user interface, the user interaction manipulating at least one of the portions; and
the computer generating a rule for generating future log file content, wherein the generated rule is based on the user interaction in the user interface.

2. The method of claim 1, wherein the manipulating comprises changing an order of two of the portions within the extracted content.

3. The method of claim 2, wherein the rule defines an order of content that corresponds to the order of the two portions.

4. The method of claim 1, wherein the manipulating comprises deleting the at least one of the portions from the extracted content.

5. The method of claim 1, wherein the rule for generating future log file content includes a condition for generating future log file content.

6. The method of claim 5, wherein the condition is selected from the group consisting of a record identification (ID), a user ID, and a record status.

7. The method of claim 1, further comprising the step of the computer providing the rule for generating to the one or more computer programs.

8. A computer program product for changing log file content generation, the computer program product comprising:
one or more computer-readable tangible storage devices and program instructions stored on at least one of the one or more storage devices, the program instructions comprising:
program instructions to extract content of a log file, the content having been generated by one or more computer programs at run-time, the content comprising a plurality of portions;
program instructions to cause the extracted content to be displayed in a user interface;
program instructions to receive an indication of a user interaction in the user interface, the user interaction manipulating at least one of the portions; and
program instructions to generate a rule for generating future log file content, wherein the generated rule is based on the user interaction in the user interface.

9. The computer program product of claim 8, wherein the manipulating comprises changing an order of two of the portions within the extracted content.

10. The computer program product of claim 9, wherein the rule defines an order of content that corresponds to the order of the two portions.

11. The computer program product of claim 8, wherein the manipulating comprises deleting the at least one portions from the extracted content.

12. The computer program product of claim 8, wherein the rule for generating future log file content includes a condition for generating content.

13. The computer program product of claim 12, wherein the condition is selected from the group consisting of a record identification (ID), a user ID, and a record status.

14. The computer program product of claim 8, further comprising program instructions, stored on at least one of the one or more storage devices, to provide the rule for generating to the one or more computer programs.

15. A computer system for changing log file content generation, the computer program product comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to extract content of a log file, the content having been generated by one or more computer programs at run-time, the content comprising a plurality of portions;
program instructions to cause the extracted content to be displayed in a user interface;
program instructions to detect a user interaction in the user interface, the user interaction manipulating at least one of the portions; and
program instructions to generate a rule for generating future log file content, wherein the generated rule is based on the user interaction in the user interface.

16. The computer system of claim 15, wherein the manipulating comprises changing an order of two of the portions within the extracted content.

17. The computer system of claim 16, wherein the rule defines an order of content that corresponds to the order of the two portions.

18. The computer system of claim 15, wherein the manipulating comprises deleting the at least one portions from the extracted content.

19. The computer system of claim 15, wherein the rule for generating future log file content includes a condition for generating content.

20. The computer system of claim 12, wherein the condition is selected from the group consisting of a record identification (ID), a user ID, and a record status.
